(19) United States
(12) Patent Application Publication
(10) Pub. No.: US 2025/0125938 A1
(43) Pub. Date: Apr. 17, 2025

(54) MULTI-USER MULTIPLE INPUT, MULTIPLE OUTPUT FOR FIFTH GENERATION AND BEYOND FIFTH GENERATION COMMUNICATIONS

(71) Applicant: AT&T Intellectual Property I, L.P., Atlanta, GA (US)

(72) Inventors: Jianchun Zhou, Bellevue, WA (US); Yakun Gao, Suwanee, GA (US)

(21) Appl. No.: 18/487,014

(22) Filed: Oct. 13, 2023

(51) Int. Cl. H04L 5/00; H04L 5/14; H04W 36/08

(52) U.S. Cl. CPC H04L 5/0098; H04L 5/0035; H04L 5/14; H04W 36/085

(57) ABSTRACT

A method performed by a processing system including at least one processor includes detecting a presence of a plurality of user devices in a cell of a mobile network that deploys a carrier that supports beamforming, disabling, in response to the detecting the presence of the plurality of user devices, carrier aggregation in the cell for a first subset of the plurality of user devices that supports multi-user multiple input, multiple output communications, and activating, after disabling the carrier aggregation, multi user multiple input, multiple output communications for the first subset of the plurality of user devices.

The present disclosure relates generally to wireless communications and relates more particularly to devices, non-transitory computer-readable media, and methods for activating multi-user multiple input, multiple output (MU-MIMO) for Fifth Generation (5G) and beyond 5G (B5G) communications in frequency bands that support beamforming.

### BACKGROUND

A majority of the spectrum bands deployed in Fourth Generation (4G) Long Term Evolution (LTE) networks are fragmented frequency division duplexing (FDD) carriers having an average bandwidth of approximately 10 megahertz (MHz). Because the throughput from a single 10 MHz carrier would be unable to meet the demand from many or even most applications, the Third Generation Partnership Project (3GPP) introduced carrier aggregation in the LTE-Advanced standard. Carrier aggregation increases the peak throughput of a single user by aggregating the bandwidth of a primary cell (PCell) and one or more secondary cells (SCells).

### SUMMARY

In one example, the present disclosure describes a device, computer-readable medium, and method for activating multi-user multiple input, multiple output for Fifth Generation and beyond Fifth Generation communications in frequency bands that support beamforming. For instance, in one example, a method performed by a processing system including at least one processor includes detecting a presence of a plurality of user devices in a cell of a mobile network that deploys a carrier that supports beamforming, disabling, in response to the detecting the presence of the plurality of user devices, carrier aggregation in the cell, and activating, after disabling the carrier aggregation, multi user multiple input, multiple output communications for the first subset of the plurality of user devices.

In another example, a non-transitory computer-readable medium stores instructions which, when executed by a processor, cause the processor to perform operations. The operations include detecting a presence of a plurality of user devices in a cell of a mobile network that deploys a carrier that supports beamforming, disabling, in response to the detecting the presence of the plurality of user devices, carrier aggregation in the cell for a first subset of the plurality of user devices that supports multi-user multiple input, multiple output communications, and activating, after disabling the carrier aggregation, multi user multiple input, multiple output communications for the first subset of the plurality of user devices.

In another example, a device includes a processor and a computer-readable medium storing instructions which, when executed by the processor, cause the processor to perform operations. The operations include detecting a presence of a plurality of user devices in a cell of a mobile network that deploys a carrier that supports beamforming, disabling, in response to the detecting the presence of the plurality of user devices, carrier aggregation in the cell, and enabling, after disabling carrier aggregation in the cell for a first subset of the plurality of user devices that supports multi-user multiple input, multiple output communications, and activating, after disabling the carrier aggregation, multi user multiple input, multiple output communications for the first subset of the plurality of user devices.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for activating multi-user multiple input, multiple output for Fifth Generation and beyond Fifth Generation communications in frequency bands that support beamforming, in accordance with the present disclosure;

FIG. 3 illustrates a chart showing one non-limiting example of how spectrum efficiency, average throughput per user, and overall cell throughput can be improved when disabling carrier aggregation and activating multi-user multiple input, multiple output communications in an example cell containing fewer than eight users;

FIG. 4 illustrates a chart showing one non-limiting example of how spectrum efficiency, average throughput per user, and overall cell throughput can be improved when disabling carrier aggregation and activating multi-user multiple input, multiple output communications in an example cell containing at least eight users; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure activates multi-user multiple input, multiple output (MU-MIMO) for Fifth Generation (5G) and beyond 5G (B5G) communications in frequency bands that support beamforming. As discussed above, carrier aggregation increases the peak throughput of a single LTE user by aggregating the bandwidth of a primary cell and one or more secondary cells. However, the overhead required to achieve this increase in peak throughput sacrifices spectrum efficiency. Specifically, each additional carrier that is aggregated reduces the total throughput by approximately ten percent. As a result, even though 3GPP defines carrier aggregation up to seven component carriers (7CA), most instances of carrier aggregation never deploy beyond five component carriers (5CA), and four component carriers (4CA) and 5CA rarely tend to be activated in the network even when deployed.

Examples of the present disclosure disable carrier aggregation in 5G mid-band TDD carriers in favor of activating MU-MIMO communications. Within the context of the present disclosure, a “mid-band” TDD carrier is understood to refer to a TDD carrier that supports beamforming. Many bands operating on frequencies between 1 gigahertz (GHz) and 7.125 GHz can operate in TDD mode. For instance, 5G New Radio (NR) operates on Frequency Range 1 (FR1) and Frequency Range 2 (FR2). FR1 covers the range of 410 MHz-7.125 GHz, while FR2 covers the range of 24.25 GHz-52.6 GHz.

The 3.3 GHZ-4.2 GHz 5G spectrum band (commonly referred to as “n77”) is one particular example of a mid-band TDD carrier. Due to the large bandwidth of the n77 band, carrier aggregation provides little, if any, benefit in terms of increased throughput. Moreover, because the transmission time interval (TTI) of n77 is half that of FDD (i.e., 0.5 milliseconds versus 1 millisecond), the deployment of carrier aggregation in n77 tends to result in additional loss of spectrum efficiency due to synchronization challenges. Thus, the expected throughput gain from 2CA FDD and n77 may not be great enough to justify the loss of spectrum efficiency.

MIMO communications are typically enabled by increasing the number of antennas on a wireless router so that a single wireless access point can support multiple users simultaneously. MU-MIMO communications reuse the available bandwidth of the wireless router by creating a plurality of individual streams that share the router connection equally, where each stream may be allocated to a different user. 5G mid-band TDD carriers such as n77 can particularly benefit from a unique feature of MU-MIMO communications, which utilizes beamforming in order to allow the entire spectrum to be reused among multiple concurrent users.

Experimental results have demonstrated an approximately one hundred percent increase in downlink throughput and an approximately two-hundred percent increase in uplink throughput at the cell level when MU-MIMO is activated in a group of four space-separated users. Further increase is possible when the network supports a larger MU-MIMO group. However, current MU-MIMO implementations are limited to implementation on PCells, because MU-MIMO requires sounding re-reference signal antenna switch (SRS AS) and SRS support, which is currently unavailable on SCells.

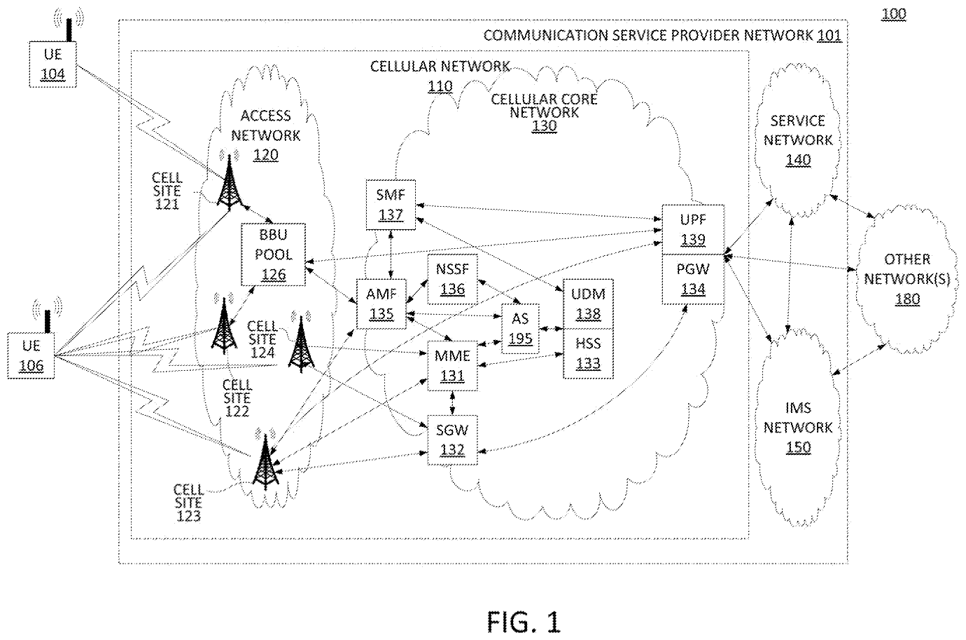

Although examples of the present disclosure are discussed within the context of the n77 band, such examples are understood to encompass all mid-band TDD carriers that support MU-MIMO (e.g., support beamforming). Moreover, although examples of the present disclosure discuss the use of MU-MIMO in conjunction with TDD carriers, it will be understood that similar benefits may be achieved by activating MU-MIMO (rather than carrier aggregation) with FDD carriers that support MU-MIMO. These and other aspects of the present disclosure are discussed in greater detail in connection with FIGS. 1-5, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. A cloud RAN, however, is just one example of a RAN with which MU-MIMO may work. MU-MIMO works with all types of RANs, including distributed RANS (D-RANs), centralized RANs (C-RANs), virtualized RANS (V-RANs), and open RANS (O-RANs).

For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

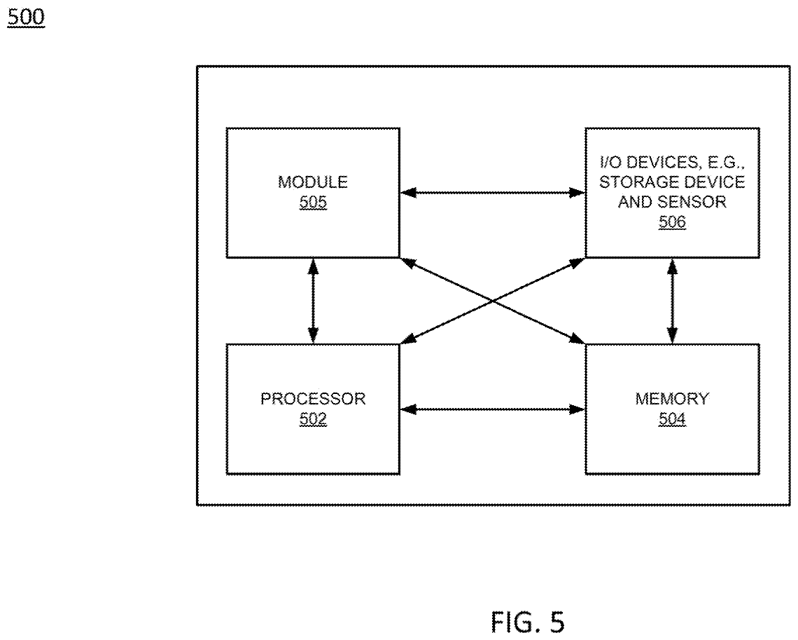

In accordance with the present disclosure, any one or more of cell sites 121-123 may be deployed with antenna and radio infrastructures, including MIMO and millimeter wave antennas. Furthermore, in accordance with the present disclosure, a base station (e.g., cell sites 121-123 and/or baseband units within BBU pool 126) may comprise all or a portion of a computing system, such as computing system 500 as depicted in FIG. 5, and may be configured to perform steps, functions, and/or operations in connection with examples of the present disclosure for disabling carrier aggregation in favor of activating multi-user multiple input, multiple output communications for 5G and B5G communications in frequency bands that support beamforming.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 500 depicted in FIG. 5, and may be configured to perform steps, functions, and/or operations in connection with examples of the present disclosure for disabling carrier aggregation in favor of deploying multi-user multiple input, multiple output communications for mid-band time division duplexing carriers. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band between 1 GHz and 7.125 GHZ. In contrast, an antenna array for 4G may be designed for operation in a frequency band less than 5 GHz, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

In accordance with the present disclosure, UE 106 may attach to any cell (e.g., a cell site/base station) of access network 120 and may provide an identification and an indication of a UE type to the cellular network 110. Where the UE 106 and/or any other UEs in the cell are determined to support mid-band TDD carriers (e.g., n77 or another mid-band TDD carrier) and MU-MIMO, the cell (e.g., the base station(s) supporting the cell) may disable carrier aggregation within the cell and may activate MU-MIMO for the UE 106 and/or other UEs in the cell. Disabling carrier aggregation and activating MU-MIMO may involve modifying a configuration of the base station(s) and/or UEs to disable certain capabilities and enable other capabilities. For instance, the base station(s) may locally disable any settings related to carrier aggregation and may send instructions to the UEs to activate 5G radios and enable MU-MIMO capabilities.

In one example, if no more than a single UE is detected in a cell, then the base station(s) serving the cell may not disable carrier aggregation, as any decrease in spectrum efficiency for a single UE may be considered an acceptable tradeoff for the throughput increase. However, if there are at least two UEs detected in the cell, then carrier aggregation may be disabled in the cell for at least one of the UEs. In some examples, the base station(s) may enable a handover to a low-band FDD carrier at the cell edge in order to extend coverage for the cell.

In one example, when more than one UE, but fewer than four UEs, is detected in the cell, and when the number of available mid-band TDD carriers in the cell is at least equal to the number of UEs detected, the base station(s) may assign one mid-band TDD carrier to each UE and activate MU-MIMO on each carrier. If more than one UE, but fewer than four UEs, is detected in the cell, but no more than a single mid-band TDD carrier is available in the cell, then the base station(s) may activate MU-MIMO on the carrier to be shared among the UEs, as long as sufficient separation exists between the UEs. “Sufficient” separation within this context is understood to comprise at least approximately fifteen degrees of angular separation on the horizontal direction for downlink (uplink typically does not require separation).

In another example, when at least four UEs, but fewer than eight UEs, are detected in the cell, the base station(s) may activate MU-MIMO on a single mid-band TDD carrier to be shared among the UEs, if it is determined that sufficient separation exists between the UEs. The base station(s) may further utilize any FDD spectrum bands that are saved from carrier aggregation for UEs that do not support the mid-band TDD carrier, or for any UEs beyond the first four UEs that share the mid-band TDD carrier.

In another example, when more than eight UEs are detected in the cell, and the cell deploys two or more mid-band TDD carriers, the base station(s) may activate MU-MIMO on each of the mid-band TDD carriers. Each mid-band carrier that is deployed with MU-MIMO may support up to four UEs in this case, assuming sufficient separation exists between the up to four UEs. As noted above, any FDD spectrum bands that are saved from carrier aggregation may be utilized for UEs that do not support the mid-band TDD carrier, or for any UEs beyond the first eight UEs that share the mid-band TDD carriers (i.e., four UEs per each mid-band TDD carrier, assuming two mid-band TDD carriers).

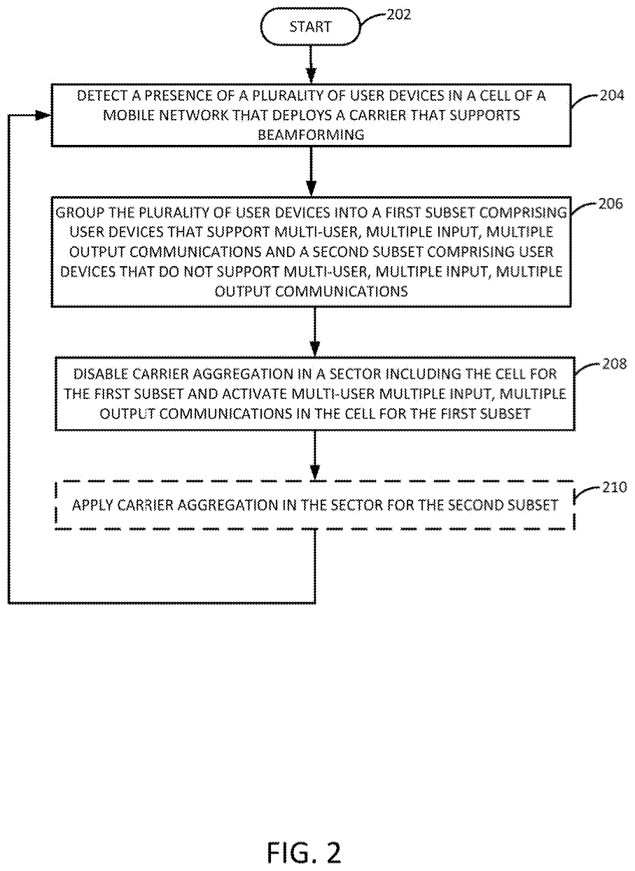

It should be noted that examples of the present disclosure as described herein primarily in connection with steps, functions, and/or operations that are performed by a cellular base station. For instance, FIG. 2 illustrates a flowchart of an example method that may be performed by a serving cell (e.g., a base station and/or any one or more components thereof). However, in other, further, and different examples, various steps, functions, and/or operations as described in connection with FIG. 2, or as described elsewhere herein, may alternatively or additionally be performed by one or more other components. For instance, various steps, functions, and/or operations may alternatively or additionally be performed by a processing system in cellular core network 130, such as application server (AS) 195, AMF 135, SMF 137, MME 131, or the like. To illustrate, in an example in which the foregoing is performed by a base station/cell site, the transmitting of the at least one instruction may be via the base station/cell site to UE 106. However, in an example in which the foregoing may be performed by AS 195, AMF 135, SMF 137, MME 131, or the like, the instruction may be to a cell sites/base station serving UE 106 to disable carrier aggregation and activate uplink MU-MIMO communications.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for activating multi-user multiple input, multiple output for Fifth Generation and beyond Fifth Generation communications in frequency bands that support beamforming, in accordance with the present disclosure. In one example, the method 200 may be performed by an application server that is configured to disable carrier aggregation in 5G mid-band TDD carriers in favor of deploying MU-MIMO communications, such as the AS 195 illustrated in FIG. 1. However, in other examples, the method 200 may be performed by another device, such as the processor 502 of the system 500 illustrated in FIG. 5. For the sake of example, the method 200 is described as being performed by a processing system.

The method 200 begins in step 202. In step 204, the processing system may detect a presence of a plurality of user devices in a cell of a mobile network that deploys a carrier that supports beamforming.

The plurality of user devices may include cellular telephones, smartphones, tablet computing devices, laptop computers, pairs of computing glasses, wireless enabled wristwatches, wireless transceivers for a fixed wireless broadband (FWB) deployment, or any other cellular-capable mobile telephony and computing devices (broadly, “endpoint devices”). For instance, at least some of the user devices in the cell may include one or more RF transceivers for cellular communications and/or for non-cellular wireless communications. In one example, at least some of the user devices in the cell may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, the carrier that supports beamforming may be a mid-band TDD carrier. For instance, the carrier may operate in a frequency between 1 GHz and 7.125 GHz. In one example, the carrier may be an n77 carrier.

In step 206, the processing system may group the plurality of user devices into a first subset comprising user devices that support multi-user multiple input, multiple output communications and a second subset comprising user devices that do not support multi-user multiple input, multiple output communications.

As discussed above, the plurality of user devices may include user devices that are equipped with MIMO antennas and are able to support MU-MIMO communications. However, some of the plurality of user devices may not be equipped with such hardware and may not be able to support MU-MIMO communications. In one example, the processing system may determine which user devices may support MU-MIMO communications and which user devices do not support MU-MIMO devices by querying the devices for their capabilities or their make and model information (which may be cross-referenced against manufacturer information in order to determine hardware and/or capabilities).

In step 208, the processing system may disable carrier aggregation in a sector including the cell for the first subset and activate multi-user multiple input, multiple output communications in the cell for the first subset.

In other words, the processing system may activate MU-MIMO communications in the sector for the first subset instead of carrier aggregation. Within this context, a “sector” is understood to refer to a physical area that includes multiple cells (where each cell may be associated with one carrier).

In one example, carrier aggregation may be disabled for the first subset by sending an instruction to one or more base stations serving the cells within the sector, where the instruction instructs a base station to modify its configuration to disable carrier aggregation for the first subset. In another example, carrier aggregation may be disabled by sending an instruction to one or more of the user devices in the first subset, where the instruction instructs a user device to modify its configuration to disable carrier aggregation.

In one example, the MU-MIMO communications may be activated in the cell by sending an instruction to one or more base stations serving the cell, where the instruction instructs a base station to modify its configuration to enable MU-MIMO communications for the first subset. In another example, the MU-MIMO communications may be activated by sending an instruction to one or more of the user devices in the first subset, where the instruction instructs a user device to modify its configuration to enable MU-MIMO communications. For instance, instructions sent to a base station and/or a user device may request that the parameters (e.g., strength and/or direction of signal reception and/or transmission) of one or more antennas at the base station and/or user device be adjusted to support MU-MIMO communications.

In one example, activation of MU-MIMO for the first subset is subject to a determination that there is sufficient separation between the user devices in the first subset. As discussed above, “sufficient” separation within this context is understood to comprise at least approximately fifteen degrees of angular separation on the horizontal direction for downlink (uplink typically does not require separation).

In one example, step 208 may also involve the processing system configuring a handover to a low-band (e.g., below 1 GHZ) FDD carrier at the cell edge to extend the coverage of the cell. Configuring the handover may involve sending an instruction to a base station that supports the FDD carrier, where the instruction instructs the base station to modify its configuration to support the handover.

In a further example, a mid-band TDD carrier that is available in the cell may be assigned to some of the user devices in the first subset, while FDD bands saved from carrier aggregation may be assigned to a remainder of the user devices in the first subset. For instance, if the first subset includes five user devices, the mid-band TDD carrier may serve four of the user devices, while the fifth user device may be assigned an FDD band that is saved from carrier aggregation.

In optional step 210 (illustrated in phantom), the processing system may apply carrier aggregation in the sector for the second subset.

In one example, carrier aggregation is applied in the sector for the second subset, without applying carrier aggregation for the first subset. In one example, carrier aggregation is applied for the second subset on a per-user device, per-carrier basis. In other words, the exact manner in how the carrier aggregation is applied for the second subset may depend upon the number of user devices in the second subset and/or the number of available carriers in the sector. For instance, if no more than a single carrier is available in the sector, then the single carrier is applied for (e.g., is shared by) all of the user devices in the second subset.

Some sectors, however, may deploy two (or more) carriers; where this is the case, each of the carriers may be assigned to (e.g., shared by) multiple user devices of the second subset. In one example, the carrier(s) assigned to the user devices in the second subset comprises at least one FDD carrier.

In one example, the at least one FDD carrier may be assigned by sending an instruction to one or more base stations serving a cell included in the sector, where the instruction instructs a base station to modify its configuration to assign the at least one FDD carrier to the user devices in the second subset as determined based on the number of user devices in the second subset and/or the number of available FDD carriers.

Once carrier aggregation and/or MU-MIMO have been activated as described for the plurality of user devices, the method 200 may return to step 204. Thus, steps 204-210 may be repeated on a periodic basis (e.g., every ten milliseconds). This ensures that as user devices leave the cell, or as new user devices enter the cell, the cell resources can be optimally activated and distributed to provide the best possible throughput for all user devices.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure improve spectrum efficiency and increase average throughput (per-user and overall) for a wireless cell. Moreover, examples of the present disclosure may reduce the processing load both in the wireless network and by the user devices by as much as fifty percent compared to 4CA. Thus, energy consumption within the network may be decreased, and battery life in the user devices may increase.

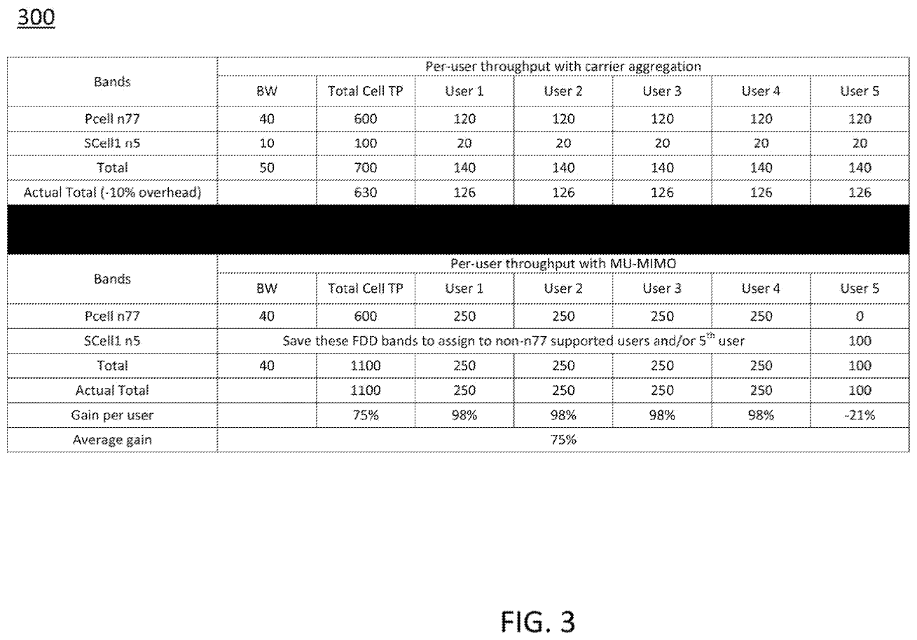

For instance, FIG. 3 illustrates a chart 300 showing one non-limiting example of how spectrum efficiency, average throughput per user, and overall cell throughput can be improved when disabling carrier aggregation and activating multi-user multiple input, multiple output communications in an example cell containing fewer than eight users.

In particular, the chart 300 shows the improvements in spectrum efficiency, average throughput per user, and overall cell throughput for an example cell containing five users (i.e., User 1 through User 5). The chart 300 assumes that the network has one n77 carrier of 40 MHz and three FDD carriers of 10 MHz each. Under these example conditions, disabling carrier aggregation in favor of deploying MU-MIMO may result in an approximately seventy-five percent increase in average throughput per user and in overall cell throughput.

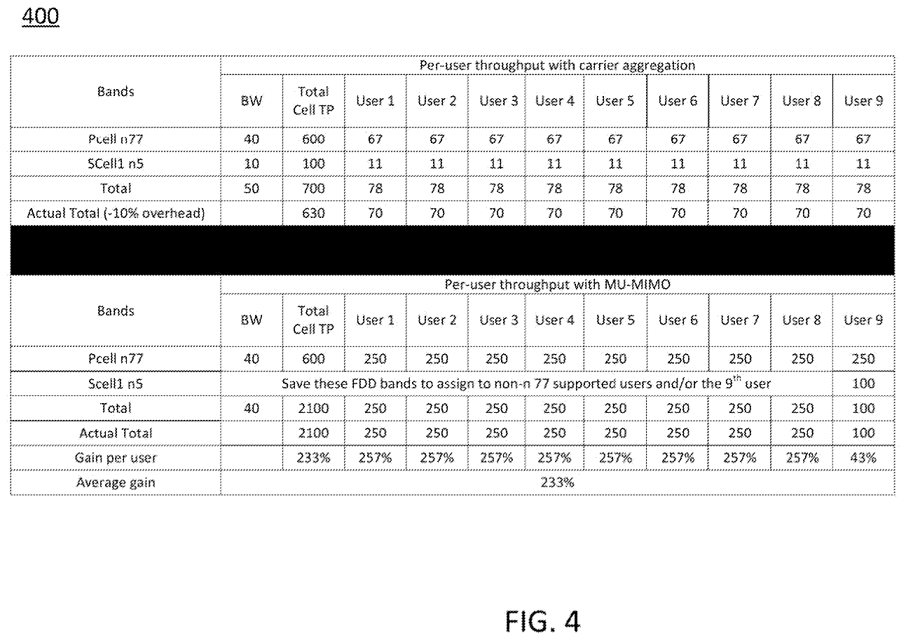

FIG. 4 illustrates a chart 400 showing one non-limiting example of how spectrum efficiency, average throughput per user, and overall cell throughput can be improved when disabling carrier aggregation and activating multi-user multiple input, multiple output communications in an example cell containing at least eight users.

In particular, the chart 400 shows the improvements in spectrum efficiency, average throughput per user, and overall cell throughput for an example cell containing nine users (i.e., User 1 through User 9). The chart 400 assumes that the network has two n77 carrier of 40 MHz each and three FDD carriers of 10 MHz each. Under these example conditions, disabling carrier aggregation in favor of deploying MU-MIMO may result in an approximately two hundred thirty-three percent increase in average throughput per user and in overall cell throughput.

In the cases of both FIG. 3 and FIG. 4, disabling carrier aggregation in favor of deploying MU-MIMO may reduce the processing load in both the network and in the user devices by approximately fifty percent. This will result in decreased energy consumption in the network and increased battery life for the user devices.

FIG. 5 depicts a high-level block diagram of a computing device specifically programmed to perform the functions described herein. For example, any one or more components or devices illustrated in FIG. 1 or described in connection with the method 200 may be implemented as the system 500. For instance, an application server (such as might be used to perform the method 200) could be implemented as illustrated in FIG. 5.

As depicted in FIG. 5, the system 500 comprises a hardware processor element 502, a memory 504, a module 505 for activating multi-user multiple input, multiple output for Fifth Generation and beyond Fifth Generation communications in frequency bands that support beamforming, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for activating multi-user multiple input, multiple output for Fifth Generation and beyond Fifth Generation communications in frequency bands that support beamforming may include circuitry and/or logic for disabling carrier aggregation in a cell deploying a carrier that supports beamforming and activating MU-MIMO communications. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for activating multi-user multiple input, multiple output for Fifth Generation and beyond Fifth Generation communications in frequency bands that support beamforming (e.g., a software program comprising computer-executable instructions) can be loaded into memory 504 and executed by hardware processor element 502 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for activating multi-user multiple input, multiple output for Fifth Generation and beyond Fifth Generation communications in frequency bands that support beamforming (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, a presence of a plurality of user devices in a cell of a mobile network that deploys a carrier that supports beamforming;
disabling, by the processing system in response to the detecting the presence of the plurality of user devices, carrier aggregation in the cell for a first subset of the plurality of user devices that supports multi-user multiple input, multiple output communications; and
activating, by the processing system after disabling the carrier aggregation, multi user multiple input, multiple output communications for the first subset of the plurality of user devices.

2. The method of claim 1, wherein the carrier that supports beamforming is a time division duplexing carrier.

3. The method of claim 2, wherein the time division duplexing carrier operates in a frequency spectrum falling within a range of 1 gigahertz to 7.125 gigahertz.

4. The method of claim 3, wherein the time division duplexing carrier comprises an n77 carrier.

5. The method of claim 1, wherein at least one user device in the first subset of the plurality of user devices is equipped with a multiple input, multiple output antenna.

6. The method of claim 1, wherein at least one base station serving the cell is equipped with a multiple input, multiple output antenna.

7. The method of claim 1, wherein the disabling further comprises configuring a handover to a frequency division duplexing carrier at an edge of the cell.

8. The method of claim 7, wherein the frequency division duplexing carrier operates in a frequency spectrum falling below 1 gigahertz.

9. The method of claim 7, wherein the handover extends a coverage of the cell.

10. The method of claim 1, wherein the cell deploys a number of instances of the carrier that supports beamforming that is at least equal to a number of user devices in the first subset.

11. The method of claim 10, wherein the activating comprises assigning one instance of the instances of the carrier that supports beamforming to each user device in the first subset of the plurality of user devices.

12. The method of claim 1, wherein the cell deploys a number of instances of the carrier that supports beamforming that is fewer than a number of user devices in the first subset.

13. The method of claim 12, wherein the activating comprises activating the multi user multiple input, multiple output communications on the number of instances of the carrier that supports beamforming in a manner that allows at least one instance of the number of instances to be shared by two user devices in the first subset.

14. The method of claim 1, wherein a separation between user devices in the first subset of the plurality of user devices is at least fifteen degrees of angular separation on a horizontal direction for downlink.

15. The method of claim 1, further comprising:
applying, by the processing system, the carrier aggregation for a second subset of the plurality of user devices that does not support multi-user multiple input, multiple output communications.

16. A non-transitory computer-readable medium storing instructions which, when executed by a processing system including at least one processor, cause the processing system to perform operations, the operations comprising:
detecting a presence of a plurality of user devices in a cell of a mobile network that deploys a carrier that supports beamforming;
disabling, in response to the detecting the presence of the plurality of user devices, carrier aggregation in the cell for a first subset of the plurality of user devices that supports multi-user multiple input, multiple output communications; and
activating, after disabling the carrier aggregation, multi user multiple input, multiple output communications for the first subset of the plurality of user devices.

17. The non-transitory computer-readable medium of claim 16, wherein the carrier that supports beamforming is a time division duplexing carrier.

18. The non-transitory computer-readable medium of claim 16, wherein a separation between user devices in the first subset of the plurality of user devices is at least fifteen degrees of angular separation on a horizontal direction for downlink.

19. The non-transitory computer-readable medium of claim 16, wherein the operations further comprise:
applying the carrier aggregation for a second subset of the plurality of user devices that does not support multi-user multiple input, multiple output communications.

20. A device comprising:
a processing system including at least one processor; and
a computer-readable medium storing instructions which, when executed by the processing system, cause the processing system to perform operations, the operations comprising:
detecting a presence of a plurality of user devices in a cell of a mobile network that deploys a carrier that supports beamforming;
disabling, in response to the detecting the presence of the plurality of user devices, carrier aggregation in the cell for a first subset of the plurality of user devices that supports multi-user multiple input, multiple output communications; and
activating, after disabling the carrier aggregation, multi user multiple input, multiple output communications for the first subset of the plurality of user devices.
